(19) United States
(12) Patent Application Publication
(10) Pub. No.: US 2017/0226424 A1
(43) Pub. Date: Aug. 10, 2017

(54) WOOD MODIFICATION TO ENHANCE FIRE RETARDANCY

(71) Applicants: Ronald Philip MOON, Auckland (NZ); CHEMENZ LIMITED, Auckland (NZ)

(72) Inventor: Ronald Philip Moon, Auckland (NZ)

(21) Appl. No.: 15/502,064

(22) PCT Filed: Aug. 7, 2015
(86) PCT No.: PCT/NZ2015/050103

§ 371 Date: Feb. 6, 2017

(30) Foreign Application Priority Data
Aug. 7, 2014 (NZ) 628380

(51) Int. Cl. C09K 21/02; B27K 5/00; B27K 3/02

(52) U.S. Cl. CPC C09K 21/02; B27K 3/02; B27K 5/001; B27K 2240/30

(57) ABSTRACT

The co-formulation of a wood preservative (‘treated’) with an inorganic (alkali metal silicates) based flame retardant which undergoes chemical impregnation. Once the ‘treated flame retardant” working solution has fully penetrated (sapwood) into the wood, it then undergoes a heat (fixation) process using various heating schedules to achieve chemical fixation. The treated flame retardant Modified Wood [tfrMW] products are then tested for their enhanced fire performance properties. When heated, wood undergoes thermal degradation and combustion producing gases, vapours, tars & chars. Using the ‘cone calorimeter’ test method, the [tfrMW] products showed a significant reduction in the following parameters: heat release rate (HRR), mass loss rate (MLR) & smoke generated (SEA) values compared to untreated radiata pine.

### FIELD

The purpose of this invention is to provide a wood modification treatment method that enhances the durability & fire retardancy properties of treated & untreated wood products. The treatment method relies on the impregnation of various wood preservatives, flame retardants (adjuvants) & other additives followed by the final wood modification heat process step to produce a range of treated flame retardant Modified Wood [tfrMW] products.

### BACKGROUND

Development in the area of wood modification has increased significantly due to the demand & need to enhance the properties of treated & untreated wood products. Current heat treatment & chemical treatment processes applied to most wood species fail to achieve & meet the level of durability (for both fungal decay & insect attack, mainly termites) & fire Retardancy prescribed by the prevailing territorial (country) standards.

While conventional Chemical Treated timber involves the impregnation of lignocellulosic material such as timber products with chemical preservatives & other like compositions, using various vacuum & pressure cycles, which are generally limited to dry substrates in order to provide ‘free space’ to accommodate the additional fluid uptake ‘working solution’ requirements. It is in the addition of the flame retardant (inorganic non-toxic) products to the ‘working solution’ either in conjunction with the various water based chemical preservatives or without the wood preservatives that determines the effectiveness of the treatment penetration throughout the wood substrate. The treatments must meet the required product retentions (loadings—kg's per m3) & penetrations covered either within the prevailing standards for durability & fire retardancy.

Using “Chemical Impregnation Modification” [CIM] technology has allowed the facilitation of impregnating the cell wall with a single or combination of chemicals (wood preservative plus flame retardant), that then react to form a material that is ‘fixed’ into the cell wall of the wood. In the case of treated flame retardant Modified Wood [tfrMW], the modification is achieved through the addition of inorganic or organic ‘non-toxic’ flame retardants to water borne chemical preservatives (approved for use in H3, H4, H5, UC3A, UC3B, UC4 & UC5) followed via heat (fixation) process. This same “Chemical Impregnation Modification” technology can also be applied to Thermally Modified Timber (TMT), where similarly the modification is achieved through the addition of inorganic or organic ‘non-toxic’ flame retardants with water borne chemical preservatives or without wood preservatives followed via heat (fixation) process.

With treated flame retardant Modified Wood [tfrMVV] & treated flame retardant Thermally Modified Timber [tfrTMT] it is the inorganic or organic ‘non-toxic’ flame retardants additives which provide increased fire retardancy to the treated wood.

For ‘Impregnation Modification’ to occur the impregnant molecules (chemical(s) must be of a sufficiently small size by which to enter the cell wall (pore diameter less than 5 nm). As the wood swells the void volume (‘micro-pores’) in the cell wall increases which are then filled with liquid chemical(s) (called ‘working solution’) which fixes chemically via various reaction mechanisms. All of the treated and untreated wood species used include; radiata pine, western red cedar, southern yellow pine, scots pine, and douglas fir.

The treated wood preservative is fully impregnated & bonded into the wood via various treatment processes, which achieves a fully compliant product both in terms of penetration & retention (correct chemical loading—kgs/m3), to meet required hazard classes H3, H4, H5). The impregnation of the flame retardant enters the wood voids (cell wall, lumena) as a monomer & on heating undergoes condensation reaction (dehydration process) whereby unbound water polymerises to produce a longer chain polymeric flame retardant species. The now fixed flame retardant suppresses the combustion properties of the [tfrMW]. The gas combustion of flame retardants (Gay-Lussac) is based on the theory that flame retardant (Alkaki metal silicates) produce non-combustible gases which in turn dilute the flammable gases of wood. The theory indicates that the flame is dissipated by an endothermic change in the flame retardant with the heat supplied from the source is conducted away from the wood at such a rate that that combustion temperatures are never achieved.

While a number of ‘prior art’ publications, documents & papers may have been referred to in compiling this patent, they do not constitute an admission that any of these documents form part of the knowledge, inventiveness & uniqueness in the art, in New Zealand or globally.

### SUMMARY OF INVENTION

The application of Chemical Impregnation Modification (CIM) technology to enhance the flame retardancy of treated (& untreated) wood can broadly summarised into 3 major areas; firstly in the product formulation to produce a treated (wood preservative) flame retardant single phase ‘working solution’, secondly the wood impregnation treatment process, whereby the ‘working solution’ impregnates into wood substrate & thirdly the heat (fixation) process which ensures that the impregnated chemicals are firmly fixed into the wood structure.

### Technical Problem

To achieve treated flame retardant Modified Wood [tfrMW] products three major areas of technical challenge must be identified and resolved.

The Product Formulations to be used require a wood preservative (water based, new generation and approved for H3, H4 & H5 hazard class uses), a flame retardant (water based adjuvant e.g. alkali metal silicates) and other additives (penetrants, water repellents, etc.). To formulate a single phase ‘soluble concentrate’ using a water based wood preservative, flame retardant and additives into a stable ‘working solution’ that after repeated pressure-vacuum treatment cycles (charges) remains stable and not effected by the various wood extractives, cellulose & lignin species. The full range of water based wood preservatives is outlined in the description of the embodiments, as are the water based range of flame retardants & additives used.

The Wood Impregnation Treatment Process uses a wide range of different treatment processes which can greatly the performance of the treated product. Also there is the challenge to use a standard conventional wood processing treatment schedules, namely; Bethel, Lowry, Reuping or a modified version that is capable of achieving the required chemical impregnation (‘working solution’ uptake—litres/m3) that meets the required standards for retention & penetration (compliance) for durability & fire retardancy.

The Heat (Fixation) Process used is required to convert the flame retardant from its smaller size monomeric state to a larger polymerise species that is insoluble being both chemically & physically bound within the wood structure. This dehydration process (or condensation reaction mechanism) that takes place with the flame retardant adjuvants (e.g. soluble metal silicates; potassium, sodium & lithium silicates) requires the necessary heat energy that will optimise this reaction mechanism. The potential heat energy sources being; radio frequency, steam & kilns.

### Solution to Problem

For the Product Formulation a wide range of water based wood preservatives (refer to ‘description of embodiments’) was used in various combinations with water based flame retardants to achieve a stable homogenous treated flame retardant ‘working solution’.

Repeated (600-700) ‘screening’ tests of the various treated (wood preservative) flame retardant ‘working solutions’ were conducted using a “Venturi—Filtration Apparatus”. This apparatus creates a vacuum filtration 70-80 kpa), whereby the working solutions are passed through a 1-5 micron (Qualitative Grade 1. Filter Paper), where the filtrate rates (measured in seconds/100 mls) of the treated flame retardant solutions are measured against the treated wood preservative (control) solutions.

While this method doesn't replicate the wood impregnation process it provides an excellent method for ‘pre-screening’ the treated flame retardant working solutions. Stability (agitated & non-agitated) over 6-9 months with the various treated flame retardant ‘working solutions’ provided a sound basis by which to use these solutions in the next stage of wood impregnation modification process via treatment plant.

The Wood Impregnation Treatment Process used on certain wood treatment processes such as reuping & low uptake modified processes generated initially good results but after repeated treatment charges produced only moderate penetration for treated flame retardant chemicals. Using the ‘full cell’ impregnation treatment process, the compliance of chemical penetration & retention (kg/m3) was able to be achieved. With further repeated treatments (charge 1, 2) using the same treated flame retardant working solution similar if not better chemical penetration & retention results were achieved.

The Heat (fixation) Process used to achieve fixation & polymerisation of the flame retardant adjuvant required elevated temperature schedules that were within the 90-130 C range but below 150 C. The heat energy sources used being high temperature kilns.

### Advantageous Effects of Invention

The advantageous effect of this invention being that treated (radiata pine) wood (H3, H4 & H5) can achieve a level of flame retardancy that will allow it to meet the Australian Bushfire & USA Forest Fire Standards. The significance & impact of this invention is that the treated flame retardant Modified Wood [tfrMW] is impregnated throughout the wood substrate making it unlike other Flame Retardant (FR) coatings acceptable. Also, the fact that this uses a homogenous treated flame retardant ‘working solution’ that requires a single treatment & heat (fixation) process all of which are able to be with existing plant and equipment is most advantageous. The [tfrMW] product also delivers other advantageous effects in terms of increased wood densification (from 450 kg/m3 to 520 kg/m3) and increased dimensional stability.

### DESCRIPTION OF EMBODIMENTS

The following description will describe the preferred embodiments of the invention, in relationship to the wood impregnation chemical formulation, treatment process & subsequent heat (fixation) process used in the impregnation modification technology for durability and the enhanced fire retardancy. This invention is in no way limited to these embodiments as they are purely to exemplify the invention only & that possible variations & modifications would be readily apparent without departing from the scope of the invention.

The specification describes the product formulation which includes an approved wood preservative with an adjuvant (e.g. alkali metal silicates) to establish the ‘working solution’ required for further wood impregnation treatment processes. The compatibility & mixing of the wood preservatives & adjuvants into a single ‘working solution’ is required prior to the following wood impregnation treatment & heat (fixation) processing steps;

Wood Impregnation Treatment process steps of:
(a) Timber is loaded into the wood treatment chamber (can be cylindrical or square vessel), then sealed shut.
(b) The chamber is then flooded under vacuum with the various ‘working solutions’, whereby allowing absorption (chemical uptake, Litres/m3) to occur. In the case of Reuping air is firstly applied to partially fill the void & allow lower ‘working solution’ uptakes to occur.
(c) Depending on the treatment process used i.e. Bethell, Lowry, Reuping or modified processes, then various pressure & vacuum cycles are applied for 30 to 180 minutes to achieve a final required ‘working solution’ uptake of 30 to 900 litres per m3.
(d) Once the timber has been fully impregnated with the required amount of wood preservative plus flame retardant (adjuvant) or just flame retardant (adjuvant), then it progresses to the next Heat processing stage.

The operating parameters for the treatment process to ensure that the wood preservative and flame retardant (adjuvant) achieve compliance are outlined below; refer also Example 1:
(a) The operating pressure ranges from 50 to 3,000 kpa depending on the various treatment processes used.
(b) The operating vacuum ranges from −10 to −90 kPa also depending on the various treatment processes used. Also these processes require initial vacuums, final vacuums, extended vacuums, etc.,
(c) The pressure & vacuum cycle times for will vary from 2 to 120 minutes depending on treatment process used.

Heat (Fixation) Process.

Once the treated flame retardant ‘working solution’ has been impregnated into the wood (via treatment process), then the wood must undergo a heat (fixation) treatment process based on time/temperature schedule. The time/temperature schedule is based on a time range of 18 to 36 hours and a temperature range (input/output) of 80 to 130 C. The time/temperature range parameters are very critical to optimise chemical fixation & not impair wood strength.

To evaluate and quantify the effectiveness of chemical fixation during this process, the leachability test is used. The Leaching Test EN 84 Method is used to evaluate fixation properties of both the wood preservative (copper based, pCu) and the flame retardant (adjuvant) in the treated flame retardant Modified Wood [tfrMW] samples. Refer to Example 2.

The treated flame retardant Modified Wood [tfrMW] applies to both lower temperatures (less than 150 C) and higher temperatures (above 150 C), which includes Thermally Modified Timber (TMT). In the case of treated flame retardant or flame retardant Modified Wood [tfrMW or frMW] for Thermally Modified Timber, the wood firstly undergoes chemical impregnation followed by being placed in a specific ‘thermal modification heat kiln’ where via a series of process steps reaches an elevated temperature of at least 190 C & up to 250 C at which point thermal modification has occurred.

### DESCRIPTION OF EMBODIMENTS

### Example 1

Wood Impregnation Treatment Process

Background of the Invention

The preservative treatment of wood by pressure methods is the preferred commercial approach as it achieves greater efficiency in controlling the conditions & effectiveness in terms of achieving more uniform, deeper penetration & greater adsorption of the working solution. The treatment plant has door either at I or both ends to receive the untreated wood (charge), which is then loaded into the vessel ready for the treatment to occur. The plant has various accessory equipment such as working tanks, flood lines, controls, vacuum & pressure pumps to deliver the various treating schedules.

There are 2 types of treatment pressure methods; firstly “empty cell process” where compressed air is applied to the timber prior to the wood preservative “working solution” is applied. The wood preservative is added to the vessel from an equalising tank where the air interchanges with the preservative. By trapping the air in the cells and releasing the pressure after treatment, the trapped air expands & forces the preservative out, with a final vacuum to remove any further solution. This process leaves no preservative in cell lumens & recovers much of the preservative used.

The ‘full cell process” uses an initial vacuum removing much of air from the cells, thereby removing the air cushion which resists preservative penetration. This process achieves the maximum retention of the chemical preservative in the treatment of the wood.

There is also “modified full-cell process” is basically the same as the “full-cell process” except that it uses lower levels of initial vacuum and often uses an extended final vacuum. Modified full-cell process is the most commonly used method of treating wood with waterborne preservatives.

In wood treatment being ‘Fit for Purpose’ is critical and the various hazard classes or user categories (H3, H4, H5, or UC3B, UC4B) must meet compliance through Penetration and Retention. Both penetration & retention are a function of the treatment process, hence the importance of the correct treatment schedule for the appropriate wood species, grade & size.

The Treatment carried out using the ‘treated flame retardant’ working solution being the “full cell process”, as require full penetration and a retention that would support the durability & a sufficient loading of flame retardant chemical to meet the heat testing method required by Australian Bushfire (‘cone calorimetry”) and the USA ‘Spread of Flames” testing requirements.

Using structural grade (mpg10) radiata pine, the ‘working solution’ (treated flame retardant) has undergone ‘full cell’ treatment process with 2 consecutive charges (1. & 2.), results of chemical uptakes, penetration & retention levels outlined in Table 1.

TABLE 1
Impregnation Treatment data for treatment charges
1 & 2, showing treated flame retardant results
for Chemical Uptake, Penetration & Retentions

| | | | | Chemical | |
|---|---|---|---|---|---|
| | Sapwood to | | Chemical | Retention (kg/m3) | |
| Sample | Heartwood | Penetration | Uptake | | Flame |
| Number | content (%) | (%) sapwood | (xL/m3) | Copper | Retardant |

Treatment Charge 1
(Radiata pine - mpg 10 structural grade, size 90 × 45 × 250 mm)

| | | | | | |
|---|---|---|---|---|---|
| 1A/L | 75% | 100% | 327 | 1.1 | 45.8 |
| 2A/L | 100% | 100% | 776 | 2.7 | 108.6 |
| 3A/L | 40% | 100% | 351 | 1.3 | 49.1 |
| 4A/L | 100% | 100% | 784 | 2.7 | 109.7 |
| 5A/L | 100% | 100% | 780 | 2.7 | 109.2 |
| 6A/L | 100% | 100% | 628 | 2.2 | 88.0 |
| 7A/L | 100% | 100% | 695 | 2.4 | 97.3 |
| 8A/L | 90% | 100% | 576 | 2.0 | 80.6 |
| 9A/L | 100% | 100% | 776 | 2.7 | 108.6 |
| 10A/L | 100% | 100% | 754 | 2.6 | 105.6 |
| Total (av.) | | | 645 | 2.3 | 90.3 |

Treatment Charge 2
(Radiata pine - mpg 10 structural grade, size 90 × 45 × 250 mm)

| | | | | | |
|---|---|---|---|---|---|
| 11A/L | 95% | 100% | 644 | 2.3 | 90.2 |
| 12A/L | 100% | 100% | 734 | 2.6 | 102.8 |
| 13A/L | 100% | 100% | 741 | 2.6 | 103.7 |
| 14A/L | 100% | 100% | 755 | 2.6 | 105.7 |
| 15A/L | 100% | 100% | 718 | 2.5 | 100.5 |
| 16A/L | 100% | 100% | 734 | 2.6 | 102.8 |
| 17A/L | 100% | 100% | 715 | 2.5 | 100.1 |
| 18A/L | 100% | 100% | 730 | 2.6 | 102.2 |
| 19A/L | 100% | 100% | 737 | 2.6 | 103.2 |
| 20A/L | 50% | 100% | 643 | 2.3 | 90.0 |
| Total (av.) | | | 715 | 2.5 | 100.1 |

The treatment (charges 1 & 2) for the treated flame retardant ‘working solutions’ gave results for treatment charge 1. (numbers 1A/L to 10A/L) the chemical uptake values of 645 kg/L (average), which represents a chemical retention of copper (2.3 kg/m3, H4) and a flame retardant loading of 90 kg/m3. Similarly with treatment charge 2. (numbers 11A/L to 20A/L) the chemical uptake values of 715 kg/L (average), which represents a chemical retention of copper (2.5 kg/m3, H4) and a flame retardant loading of 100 kg/m3.

At these copper loading levels the wood (radiata pine) retentions values are 0.54% m/m—Cu which exceeds an H4 hazard class. For the copper based iwood preservatives, the copper (Cu) spot tests (rubeanic test) is carried out in accordance with AS/NZS 3640/1604.

### DESCRIPTION OF EMBODIMENTS

### Example 2

Heat (Fixation) Process

Background of the Invention

Once the treated flame retardant timber has been treated it has a high moisture content (% mc) in the range 60-100% which requires drying to bring it below 18% mc for resale. It is in the drying process where various kiln schedules are used in the control of temperature (set points), air flow (fans) & relative humidity at pre-determined times. The kiln schedules require temperature range for inlet temperature (wet bulb) to be 70-100 C & the outlet temperature (dry bulb) to be 100-130 C. The initial time-temperature being 1-2 hours for 18-36 hours then back down to ambient temperature. Pre steaming can also be used in the initial phase. Other heat sources can also be used like steaming, radio frequency & microwave.

The heat (fixation) process and the conditions required to achieve this are critical as it achieves 2 important processes in firstly reducing the moisture content (% mc) & secondly provides the energy to activate the condensation reaction mechanism (dehydration process) whereby the unbounded water molecules in the flame retardant (silicate ions) undergo polymerisation to produce larger & bound molecules within the wood cells—this is chemical fixation of the flame retardant. The chemical fixation is validated by the leaching test for both the wood preservative & flame retardant (alkali metal silicates), as outlined in Table 2 & 3.

TABLE 2
Leaching (Fixation): Copper (wood preservative, pCu) Loss
Rate (leaching test method EN84) for radiata pine

| | Sample #4 | Sample #6 | Sample #14 | Sample #17 |
|---|---|---|---|---|
| Day 1 | 0.43% | 0.47% | 0.54% | 0.71% |
| Day 8 | 0.43% | 0.37% | 0.29% | 0.17% |
| Day 14 | 0.15% | 0.18% | 0.16% | 0.09% |

The leaching (leachate solutions) results (samples 4, 6, 14, 17) for copper in the copper based wood preservative (pCu) all gave significantly low values after 14 days, with gradient drop-off rates ranging from 42% at day 1 (0.53%) to day 8 (0.31%) & 55% from day 8 to day 14 (0.14%). This pCu depletion rate is well within an acceptable level to maintain wood durability for the required hazard classes.

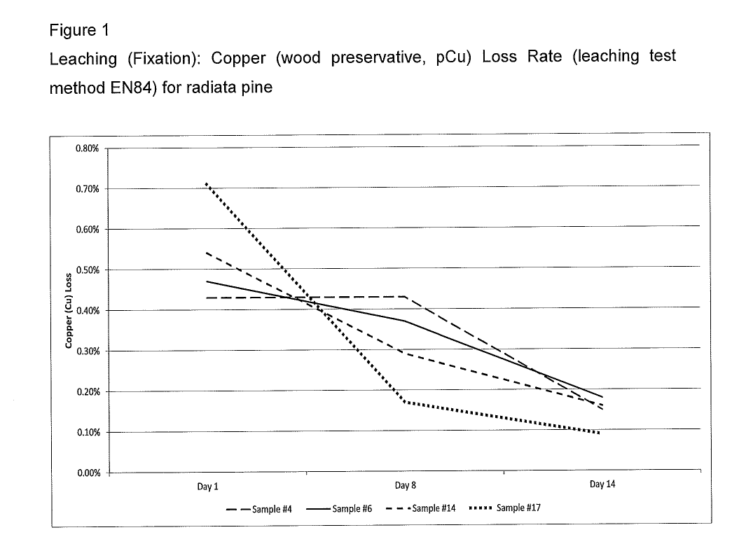

Refer to FIG. 1. (Drawing 1/4) Leaching (Fixation): Copper (wood preservative, pCu) Loss Rate (leaching test Method EN84) for radiata pine.

The fixation process for treated wood preservatives such as these new generation copper based fungicides is well documented.

TABLE 3
Leaching (Fixation): Flame Retardant (FR) Loss Rate
(leaching test method EN84) for radiata pine

| | Sample #4 | Sample #6 | Sample #14 | Sample #17 |
|---|---|---|---|---|
| Day 1 | 1.6% | 1.9% | 1.0% | 0.5% |
| Day 8 | 1.1% | 1.0% | 0.9% | 0.5% |
| Day 14 | 0.8% | 0.9% | 0.8% | 0.5% |

The leaching (leachate solutions) results (samples 4, 6, 14, 17) for flame retardant (FR) content of the [tfrMW] also gave significantly low values after 14 days, with gradient drop-off of 30% from day 1 (1.2%) to 8 (0.8%) & 15% from day 8 to 14 (0.7%). This flame retardant depletion rates (via the leaching test) all follow a similar ‘drop off’ gradient and the residual rate (loss) after 14 days is highly significant in achieving fixation within the treated flame retardant Modified Wood products.

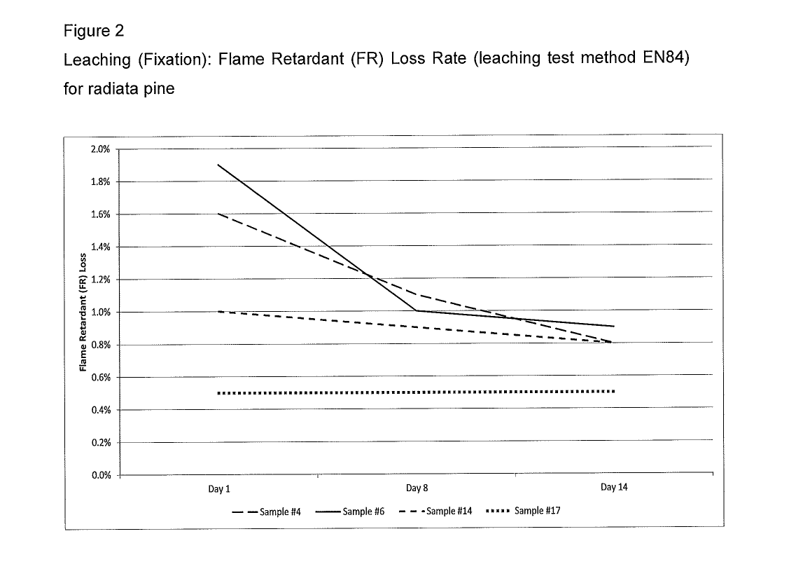

Refer to FIG. 2. (Drawing 2/4) Leaching (Fixation): Flame Retardant (FR) Loss Rate (leaching test Method EN84) for radiata pine.

LEACHING TEST EN84 METHOD. Leaching Test samples were conditioned in the same way as it had been done before impregnation (65% RH and 20° C. till equilibrium moisture content). Leaching was done according to EN84. Samples were covered with deionized water in an amount of approximately five times the volume of the sample and placed in the impregnation vessel. Samples were held in 0.04 bar of vacuum for 20 min. After vacuum, the samples stayed in the water for 2 hr before the water was changed for the first time. Specimens were submersed in deionized water for 14 days. From every sample's vessel, 5 ml of leaching water was collected, combined and submitted for chemical analyses. Water changes and collecting of water samples were done ten times.

### DESCRIPTION OF EMBODIMENTS

### Example 3

Heat Release Rate (HRR)

Background of the Invention

The impact of the treated fire retardant Modified Wood [tfrMW] products on the combustion properties can be demonstrated in EXAMPLES 3, 4 & 5.

The cone calorimeter will evaluate fire performance properties such as fire degradation, smoke emission & heat release. The TTI (Time to Ignition), HRR (heat Release Rate), & THR (Total Heat Release) are important parameters for evaluating the combustion of biomaterials, whereas MLR (Mass Loss Rate) and smoke (SEA) Smoke Extinction Area will evaluate the extent of mass loss and smoke generated during combustion.

Heat Release Rate (HRR). The TTI of [tfrMW] samples was dramatically increased from 28 sec to 160 sec which caused combustion to occur later than in the lower untreated wood value. While having an extended TTI, it's the reduction in HRR of the [tfrMW] that is most important during the combustion process. The average HRR (av-HRR) & peak HRR (pk-HRR) values of [tfrMW] were 75% & 60% lower than those of the untreated wood, respectively.

A lower pk-HRR is preferable to reduce the intensity of fires and has a positive impact on the combustion behaviour of [tfrMW] wood. The [tfrMW] significantly reduced the initial peak (volatile pyrolysis gases) after which the HRR curve was smooth much reduced going down to 25 kW/m2 after 600 sec, then remaining at that level through to 1200 sec (20 min.) & even further to 1800 sec (30 min). The impregnated & fixed flame retardant has severely modified the combustion properties of the treated wood—refer to Table 4 below.

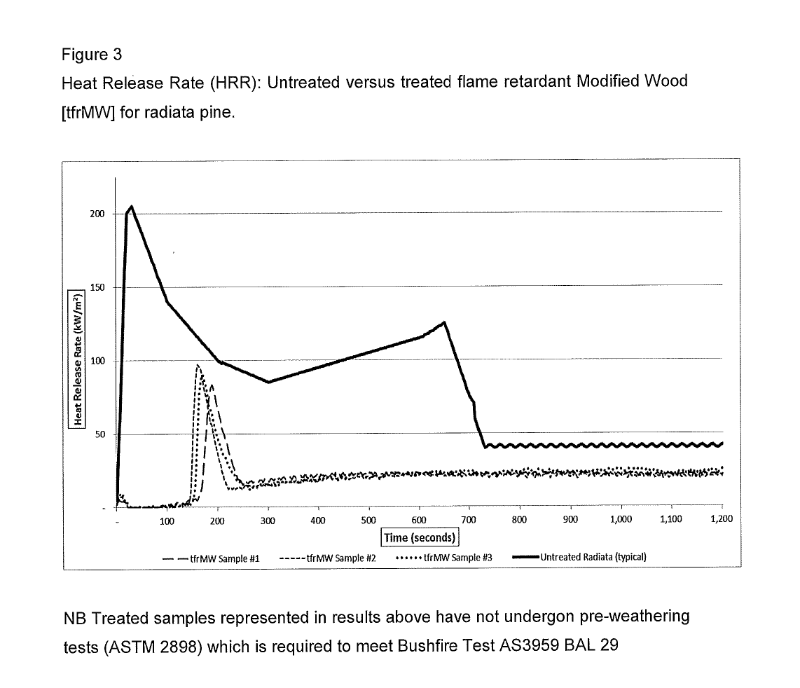

TABLE 4
Heat Release Rate (HRR): Untreated versus treated flame
retardant Modified Wood [tfrMW] for radiata pine.
Also refer to FIG. 3 (Drawing 3/4)

| Time | Sample | Sample | Sample |
|---|---|---|---|
| (sec) | 1 | 2 | 3 |
| — | 2.52 | 5.01 | 2.37 |
| 10 | 4.12 | 7.54 | 9.21 |
| 20 | 0.97 | 1.29 | 3.35 |
| 30 | — | — | — |
| 40 | — | — | 0.41 |
| 50 | — | — | — |
| 60 | — | — | 0.02 |
| 70 | 0.09 | — | 0.76 |
| 80 | — | — | — |
| 90 | 1.39 | — | 1.37 |
| 100 | 1.66 | — | 1.50 |
| 110 | 1.18 | 0.30 | 0.31 |
| 120 | 3.22 | 1.29 | 2.39 |
| 130 | 2.75 | 0.53 | 2.89 |
| 140 | 4.45 | 1.35 | 1.98 |
| 150 | 5.63 | 42.90 | 4.78 |
| 160 | 5.14 | 96.95 | 52.19 |
| 170 | 21.27 | 85.70 | 90.23 |
| 180 | 67.50 | 67.44 | 73.73 |
| 190 | 81.38 | 51.08 | 59.72 |
| 200 | 67.10 | 35.24 | 46.18 |
| 210 | 51.17 | 21.66 | 35.91 |
| 220 | 39.17 | 12.34 | 29.13 |
| 230 | 28.07 | 12.51 | 22.56 |
| 240 | 18.76 | 13.56 | 17.76 |
| 250 | 16.22 | 12.86 | 15.42 |
| 260 | 16.01 | 14.34 | 13.03 |
| 270 | 16.81 | 14.32 | 13.94 |
| 280 | 17.12 | 14.77 | 14.93 |
| 290 | 17.90 | 16.07 | 15.23 |
| 300 | 17.27 | 16.25 | 15.95 |
| 310 | 17.71 | 16.43 | 15.58 |
| 320 | 19.62 | 16.74 | 15.09 |
| 330 | 20.45 | 16.78 | 16.65 |
| 340 | 20.68 | 17.05 | 16.51 |
| 350 | 20.91 | 16.51 | 17.33 |
| 360 | 21.10 | 16.09 | 15.52 |
| 370 | 20.34 | 16.84 | 18.10 |
| 380 | 18.95 | 17.35 | 19.33 |
| 390 | 20.16 | 18.42 | 17.19 |
| 400 | 20.24 | 18.24 | 18.57 |
| 410 | 20.67 | 19.48 | 19.67 |

### DESCRIPTION OF EMBODIMENTS

### Example 4

Mass Loss Rate (MLR)

Background of the Invention

The thermal decomposition behaviour of the mass loss rate reflects the combustion process and is related to the heat release and smoke production. The first stage of MLR curve (untreated radiata pine) mostly due to the elimination of moisture from the wood.

The second stage (charring) of thermal decomposition process mostly involves combustion of major wood components, including cellulose, hemicellulose & lignin. Results of the MLR analysis show that the [tfrMW] significantly (severely) influences the thermal decomposition behaviour of the wood. The MLR curves follows very similarly to the HRR curve (‘M’ curve) for both untreated radiata pine and [tfrMW] but at a significantly reduced level. The average MLR for untreated radiata pine is 0.085 g/sec compared to [tfrMW] 0.050 g/sec, a significant 42% reduction—refer to Table 5 below.

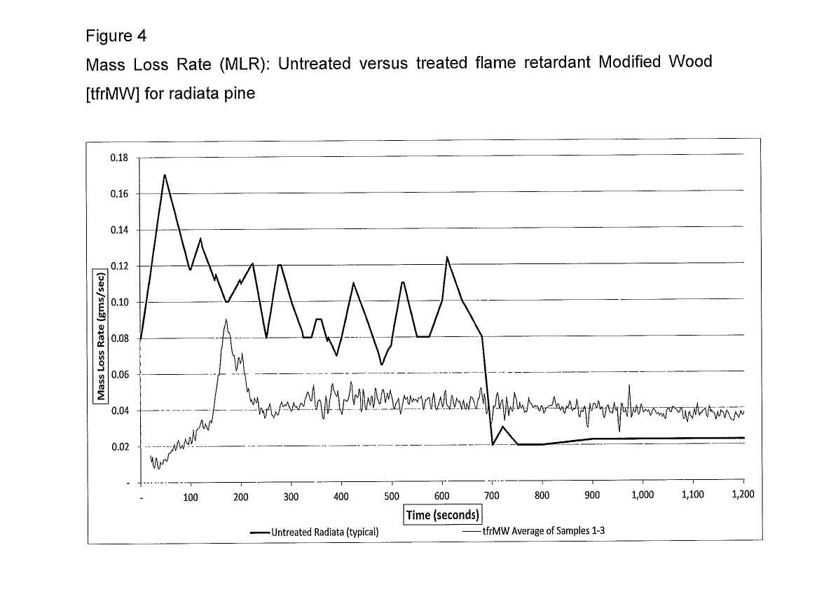

TABLE 5
Mass Loss Rate (MLR): Untreated versus treated flame
retardant Modified Wood [tfrMW] for radiata
pine. Refer to FIG. 4 (Drawing 4/4)

| | Average |
|---|---|
| Time | Samples |
| (seconds) | 1-3 |
| — | 0.078 |
| 10 | 0.002 |
| 20 | 0.042 |
| 30 | 0.011 |
| 40 | 0.033 |
| 50 | (0.001) |
| 60 | 0.047 |
| 70 | 0.013 |
| 80 | 0.055 |
| 90 | (0.007) |
| 100 | 0.020 |
| 110 | 0.048 |
| 120 | 0.039 |
| 130 | 0.036 |
| 140 | 0.024 |
| 150 | 0.070 |
| 160 | 0.106 |
| 170 | 0.106 |
| 180 | 0.051 |
| 190 | 0.060 |
| 200 | 0.070 |
| 210 | 0.009 |
| 220 | 0.081 |
| 230 | (0.002) |
| 240 | 0.079 |
| 250 | 0.036 |
| 260 | 0.039 |
| 270 | 0.027 |
| 280 | 0.050 |
| 290 | 0.038 |
| 300 | 0.043 |
| 310 | 0.043 |
| 320 | 0.045 |
| 330 | 0.057 |
| 340 | 0.045 |
| 350 | 0.064 |
| 360 | 0.002 |
| 370 | 0.048 |
| 380 | 0.056 |
| 390 | 0.039 |
| 400 | 0.036 |
| 410 | 0.033 |

### DESCRIPTION OF EMBODIMENTS

### Example 5

Smoke Specific Extinction Area (SEA)

Background of the Invention

Untreated wood has a SEA values of 60 m2/kg compared to [tfrMW] giving an average value of 8 m2/kg (from 3 samples—7, 11, 6), an overall reduction of 87%. Based on the data and other repetitions the [tfrMW] has a very significant positive effect on the smoke release properties of the [tfrMW]. The result is of great significance regarding the safe use of the [tfrMW] wood for indoor/outdoor applications. Smoke generation (production) is the most important factor in wood safety, even more so than heat release. Untreated wood produces SEA values in the range 25-100 m2/kg, with untreated radiata pine having a value of 60 m2/kg—refer to Table 6 below.

TABLE 6
Smoke Specific Extinction Area (SEA): Untreated versus treated flame
retardant Modified Wood [tfrMW] for radiata pine.

| Products | |
|---|---|
| Treated flame retardant Modified Wood | average smoke Specific |
| [tfrMW] Samples | Extinction Area - SEA (m2/kg) |
| Sample 1. | 7 m2/kg |
| Sample 2. | 11 m2/kg |
| Sample 3. | 6 m2/kg |
| Total average of all 3 samples | 8 m2/kg |
| Untreated radiata pine | 60 m2/kg |

Overall the combustion properties, thermal decomposition and smoke emission behaviour of treated flame retardant Modified Wood [tfrMW] samples, showed a significant reduction in all 3 factors confirming the occurrence of wood modification.

### DESCRIPTION OF EMBODIMENTS

### Industrial Applicability

The global opportunity to enhance treated (& untreated) with flame retardants that meet the Australian Bushfire & USA Forest fire standards is enormous in range of products and generated revenue. The Australian Bushfire market size is currently A$400 million per ann. and continues to grow with the expansion of “bushfire prone areas”. The USA Forest fire market is in excess of US$1.5 billion/ann. & continues to grow exponentially. The use of this Chemical Impregnation Technology (CIT) is specifically suited to certain wood species in particular radiata pine which has a great propensity to absorb high volumes of chemicals. The treated flame retardant chemicals must have high uptakes especially the flame retardant in order to meet penetration & retention values (compliance). While there are other wood species that can meet the flame retardant standards they are either in limited supply, indigenous (illegal to harvest) or have other limiting characteristics such as strength, dimensional stability, etc., With radiata pine it is a regenerative product, abundant in supply (NZ, Australia & Chile), low cost, readily processed and treated with existing plant and equipment.

The CIT can be used on a wide of outdoor wood product applications including; Solid wood products—structural bearers, joists, decking, fencing, weatherboards, trim boards & landscape, Engineered wood products—finger jointed weatherboards & trim boards, beams bearers, plywood, LVL, glulam products. Being a treated flame retardant product it can be used for H3 (or UC3A & B) applications as above but also for other higher retention H4 & H5 applications—in-ground posts, poles, power poles, fencing, vineyards, etc.

While there are a diverse range of product applications for this CIT technology to enhance flame retardancy, it is in the channel to market supply chain that is most critical in establishing the success of such a patented product. Chemenz Limited (the applicant & inventor) have established global distribution rights with a major wood wholesaler having manufacture & distribution in all 4 major countries; New Zealand, Australia, Chile & USA.

In terms of industrial applications the focus has been on a treated flame retardant product, however, the CIT technology also deliver other value added propositions such as dimensional stability, densification, water repellences and colouration. These other value propositions are secondary however will contribute to the overall value of modified products. The other industrial application for CIT is in the use of thermally modified timber (TMT), whereby the timber is firstly impregnated with treated flame retardant or just the flame retardant the subjected to the thermal modification kilns, which operate at very high temperatures (150-250 C) and will deliver a very dimensionally stable flame retardant product which the TMT market desperately requires.

### CITATION LIST

### Patent Literature

Slimak K. M. & Slimak R. A “Process of using Sodium Silicate to create Fire Retardant Products” (Patent No. 20090133847), Publication date: 28 May 2009.
Xing. D & Li. J. “Effects of Heat Treatment on Thermal Decomposition & Combustion Performance of Larix spp. Wood” (2014).
Lowden L. A. & Hull T. R. “Flammability behaviour of wood & a review of the methods for its reduction” (2013).
Marney D. C. O, Russell L. J., Mann R. “Fire Performance of Wood (pinus radiata) treated with Fire Retardants & a Wood Preservative” (2008).
Hugget, c., “Estimation of Rate of Heat Release by Means of Oxygen Consumption Measurements”, Fire and Materials, 4, pp. 61-65, (1980).
Fang, J. B. “Wood Fire Behaviour & Fire Retardant Treatment: Canadian Wood Council, Ottawa, Canada (1966).
Holmes, C. A “Effect of Fire-Retardant Treatments on Performance Properties of Wood” (1977).
Sweet, M. S., LeVan, S. L., Tran, H. C., & DeGroot, R. C. “Fire performance of wood treated with combination fire-retardant and preservative systems” (1996).
Peng, Y, Yousoo, H, Gardner, D. J. “Sodium Silicate coated wood” (2010).
Babrauskas, V. and Grayson, S J, “Heat Release in Fires”, Elsevier Applied Science, London:′ (1992).
Moghtaderi, B., “Combustion Characteristics of Solid Fuels Under Fire Conditions”, PhD Thesis, The University of Sydney, Australia, (1996).

### Non-Patent Literature

Rowell, R. M “Handbook of Wood Chemistry & Wood Composites” (2nd Edition)
AS1604.1 Specification for Preservative Treatment Part 1: Sawn & Round Timber” Standards Australia: Sydney, NSW, Australia (2005)
Soja, E., “The use of the cone calorimeter for determining the hazard of building material & contents in fire” BRANZ Study Report (No. 63-1995.)
AS3959-2009 “Construction of buildings in bushfire-prone areas”. Standards Australia: Sydney, NSW, Australia (2009).
AS/NZS3837 “Method of test for heat and smoke release rates for materials & products using oxygen consumption calorimeter” Standards Australia/Standards NZ Sydney, NSW, Australia & Wellington, NZ (1998).
Forest Wood Products Australia (FWPA) “Australia Outdoor Timber & Infrastructure Market (Project No. PRA213-1011, April 2011).
Forest & Wood Products Research & Development Corporation (FWPRDC) “Combining fire retardant & preservative systems for timber products in exposed applications—state of the art review” (Project No. PN04.2007]. (June 2004).
ASTM D2898. “Standard Test Method for Accelerated Weathering of Fire-Retardant treated wood for Fire-Testing”. ASTM International: West Conshohochen, Pa. (1981).

1. A process of imparting enhanced fire retardant properties to lignocellulosic material comprising of a wood preservative chemical(s) (referred to as ‘treated’) in combination with & without an alkali metal silicate (referred to ‘flame retardant’) that via a impregnation treatment process is infused into the cellular internal voids & then is polymerised via a heat process to produce an insoluble fixed ‘treated flame retardant Modified Wood’ [tfrMW] product.

2. The product produced (′treated flame retardant Modified Wood) by the process of claim 1, wherein the product(s) possess the property of increased fire retardancy

3. The product produced by the process of claim 1, wherein the ‘treated flame retardant Modified Wood, [tfrMW], generates an incremental increase in durability

4. The wood impregnation treatment process of claim 1, wherein the pressure ranges from 50 to 3,000 kpa & vacuum 0 to −90 kpa.

5. The wood impregnation treatment process of claim 1, wherein the chemical absorption (uptake) ranges from 15 to 1,000 Litres/m3 (loading)

6. The process claim 1, wherein allows for wood preservative chemical & flame retardant in the combined ‘working solution’ to co-penetrate during the wood impregnation treatment process

7. The process claim 1, wherein that the ‘treated flame retardant’ working solution during the heat process, converts from its oligomeric state (SiO2/Si) into longer chain polymeric silicon species rendering it (fixed) insoluble.

8. The process of claim 1 includes wood preservatives types; Copper Chrome Arsenate (CCA), dissolved Copper Azoles (dCA), micronized Copper Azoles (mCA), Alkaline Copper Quaternary (ACQ), micronized Copper Quaternary (mCQ) & water based Azoles.

9. The process of claim 1, includes the soluble alkali metal silicates (′flame retardant′); sodium silicate (ortho, meta, di & trisilicates), potassium silicate & lithium silicate.

10. The process claim 1, wherein allows for wood preservative chemical retentions to range from 0.1 kg/m3 copper (Cu) to 20 kg/m3 copper (Cu) for the copper based wood preservatives.

11. The process claim 1, wherein allows for the alkali metal silicates (flame retardants) chemical retentions to range from 0.2 kg/m3 Si (for Sodium, Potassium & Lithium) to 35 kg/m3 Si (for Sodium, Potassium & Lithium).

12. The process of claim 1, includes a chemical penetrant (oxygenate type) that assists in the chemical impregnation (penetration) of the alkali metal silicates.

13. The process of claim 1, wherein said other additives (i.e. water repellents, and colourants) included in the chemical formulation (working solution) & impregnation treatment process to produce other value added properties of wood such as increased dimensional stability & colour.

14. The process of claim 1, wherein allows the heat (fixation) process temperature for the ‘treated flame retardant’ to be within the range 50 C to 150 C (centigrade)

15. The process of claim 1, wherein allows the heat (fixation) process temperature for ‘treated flame retardant’ Thermally Modified Timber (TMT) in the range 150 C to 250 C

16. The process of claim 1, wherein allows the heat (fixation) process temperature for ‘flame retardant’ Thermally Modified Timber TMT) in the range 150 C to 250 C.

17. The product produced by claim 15, 16, wherein the Thermally Modified Timber (TMT) product possess the property of increased fire retardancy

18. The process of claim 1, wherein the ‘treated flame retardant Modified Wood [tfrMW] will meet the Australian Bushfire Standard (AS3959 BAL29) & the USA Forest fire Standard (ASTM E 84).

19. The process of claim 1, wherein include wood species; radiata pine (pinus radiata), western red cedar & other cedars, douglas fir, southern yellow pine, scots pine, hoop pine, slash pine & all the other soft & hard type pines.
